(19) United States
(12) Patent Application Publication
(10) Pub. No.: US 2024/0119563 A1
(43) Pub. Date: Apr. 11, 2024

(54) DETECTING A CLOSED RING IN A 3D POINT CLOUD VIA CYCLE BASIS

(71) Applicant: International Business Machines Corporation, Armonk, NY (US)

(72) Inventors: Xue Ping Liu, Beijing (CN); Fei Wang, Dalian (CN); Dan Zhang, Beijing (CN); Kun Yan Yin, Ningbo (CN); Yun Jing Zhao, Beijing (CN); Jian Long Sun, Langfang (CN); Zhi Xing Peng, Beijing (CN)

(21) Appl. No.: 17/938,202

(22) Filed: Oct. 5, 2022

(51) Int. Cl. G06T 5/20; G06F 16/901; G06T 17/00

(52) U.S. Cl. CPC G06T 5/20; G06F 16/9024; G06T 17/00; G06T 2207/10028

(57) ABSTRACT

One or more systems, devices, computer program products and/or computer-implemented methods of use provided herein relate to detecting a closed ring in a three-dimensional (3D) point cloud via cycle basis. A system can comprise a memory configured to store computer executable components; and a processor configured to execute the computer executable components stored in the memory, wherein the computer executable components can comprise a filtering component that can filter a first undirected graph of a three-dimensional (3D) point cloud, by eliminating one or more edges of the first undirected graph that are longer than an adaptive threshold, wherein filtering the first undirected graph can produce a second undirected graph; and a detection component that can detect a minimum cycle basis of the second undirected graph to determine a cycle path that can traverse an irregular annular shape that is represented by the 3D point cloud.

### BACKGROUND

The subject disclosure relates to graph theory and, more specifically, to detecting a closed ring in a three-dimensional (3D) point cloud via cycle basis.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable detection of a closed ring in a 3D point cloud via cycle basis are discussed.

According to an embodiment, a computer-implemented system is provided. The computer-implemented system can comprise a memory configured to store computer executable components; and a processor configured to execute the computer executable components stored in the memory, wherein the computer executable components can comprise a filtering component that can filter a first undirected graph of a three-dimensional (3D) point cloud, by eliminating one or more edges of the first undirected graph that are longer than an adaptive threshold, wherein filtering the first undirected graph can produce a second undirected graph; and a detection component that can detect a minimum cycle basis of the second undirected graph to determine a cycle path that can traverse an irregular annular shape that is represented by the 3D point cloud.

According to another embodiment, a computer-implemented method is provided. The method can comprise generating, by a system operatively coupled to a processor, filtering, by a system operatively coupled to a processor, a first undirected graph of a 3D point cloud, by eliminating one or more edges of the first undirected graph that are longer than an adaptive threshold, wherein filtering the first undirected graph can produce a second undirected graph; and detecting, by the system, a minimum cycle basis of the second undirected graph to determine a cycle path that can traverse an irregular annular shape that is represented by the 3D point cloud.

According to yet another embodiment, a computer program product for detecting a closed ring shape in a 3D point cloud is provided. The computer program product can comprise a computer readable storage medium having program instructions embodied therewith, the program instructions executable by a processor to cause the processor to filter, by the processor, a first undirected graph of the 3D point cloud, by eliminating one or more edges of the first undirected graph that are longer than an adaptive threshold, wherein filtering the first undirected graph can produce a second undirected graph; and detect, by the processor, a minimum cycle basis of the second undirected graph to determine a cycle path that can traverse an irregular annular shape that can be represented by the 3D point cloud.

### BRIEF DESCRIPTION OF THE DRAWINGS

FIG. 1 illustrates a block diagram of an example, non-limiting system that can detect a closed ring in a 3D point cloud via cycle basis in accordance with one or more embodiments described herein.

FIG. 2 illustrates example, non-limiting 3D point clouds in accordance with one or more embodiments described herein.

FIG. 3 illustrates example, non-limiting 3D point clouds and their corresponding undirected graphs in accordance with one or more embodiments described herein.

FIG. 4 illustrates example, non-limiting undirected graphs generated from 3D point clouds in accordance with one or more embodiments described herein.

FIG. 5 illustrates an example, non-limiting process of downsampling a 3D point cloud in accordance with one or more embodiments described herein.

FIG. 6 illustrates an example, non-limiting 3D point cloud representing an open ring shape in accordance with one or more embodiments described herein.

FIG. 7A illustrates an example, non-limiting complete undirected graph of a 3D point cloud in accordance with one or more embodiments described herein.

FIG. 7B illustrates an example, non-limiting table comprising edge distances for the undirected graph of FIG. 7A in accordance with one or more embodiments described herein.

FIG. 8 illustrates an example, non-limiting process of identifying an adaptive threshold for filtering the complete undirected graph of FIG. 7A in accordance with one or more embodiments described herein.

FIG. 9 illustrates an example, non-limiting embodiment of a 3D point cloud in accordance with one or more embodiments described herein.

FIG. 10A illustrates an example, non-limiting undirected graph in accordance with one or more embodiments described herein.

FIG. 10B illustrates an example, non-limiting table comprising edge distances for the undirected graph of FIG. 10A in accordance with one or more embodiments described herein.

FIG. 11 illustrates example, non-limiting cycle basis in an undirected graph of a 3D point cloud in accordance with one or more embodiments described herein.

FIG. 12 illustrates an example, non-limiting set of simple cycles that can be found in an undirected graph in accordance with one or more embodiments described herein.

FIG. 13 illustrates example, non-limiting cycle paths that can be found in an undirected graph of a 3D point cloud in accordance with one or more embodiments described herein.

FIG. 14 further illustrates example, non-limiting cycle paths that can be found in an undirected graph of a 3D point cloud in accordance with one or more embodiments described herein.

FIG. 15 illustrates a flow diagram of an example, non-limiting method of detecting a closed ring in a 3D point cloud via cycle basis in accordance with one or more embodiments described herein.

FIG. 16A illustrates an example, non-limiting cycle path represented by an undirected graph of a 3D point cloud in accordance with one or more embodiments described herein.

FIG. 16B further illustrates an example, non-limiting cycle path represented by an undirected graph of a 3D point cloud in accordance with one or more embodiments described herein.

FIG. 16C further illustrates an example, non-limiting cycle path represented by an undirected graph of a 3D point cloud in accordance with one or more embodiments described herein.

FIG. 17 illustrates a flow diagram of an example, non-limiting method of detecting a closed ring in a 3D point cloud via cycle basis in accordance with one or more embodiments described herein.

FIG. 18 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

In several real-world applications, it is useful to be able to detect whether a 3D point cloud model represents a closed ring (or closed annular) shape. Herein, a closed ring can mean that the point cloud forms a continuous closed contour in 3D space that can be represented by a graph. For example, in a heart ablation surgery estimation, a doctor can estimate quality of the surgery based on 3D point cloud models of the heart and the surgical hole. For example, in a heart ablation surgery a doctor needs to create a tiny scar and a good surgery requires the scars to form a closed ring. For example, if a closed annular shape is detected in a 3D point cloud model of the scar, it can indicate that the surgery is good, and if a closed annular shape is not detected in the 3D point cloud model of the scar, it can indicate that the surgery is not good. Similarly, in a 3D molecular structure of a chemical, we sometimes need to detect whether there is a similar mechanism in the 3D point cloud model of the 3D molecular structure of the chemical. However, detecting a closed ring (or closed annular) shape in a 3D point cloud model can be challenging.

For example, an annular shape represented by a 3D point cloud can have an irregular shape, so that when it is projected in a two-dimensional (2D) form, it can form an infinity shape or a shape of the number 8. For example, 3D object detection can require model training. For example, it can be difficult to find continuous shape features to represent an annular shape with a sparse point cloud, especially when the annular shape is irregular. Thus, it can be challenging to detect whether a 3D point cloud represents a closed ring shape or a closed annular shape. Due to distortions in space of the 3D point cloud, regular shapes such as a circle or an ellipse may not be suitable to represent a 3D point cloud, and it can be desirable to have a simple method of detecting a closed annular shape or a closed ring shape in a 3D point cloud representing the annular shape, wherein the annular shape can be irregular. Accordingly, one or more embodiments discussed herein can enable detection of a cycle connected domain (e.g., closed ring) in a 3D point cloud via cycle basis, wherein a 3D point cloud can be represented by an undirected graph that can enable detection of a cycle path representing the closed ring. By doing so, presence of distortions and folds in a 3D point cloud may not affect detection of a closed ring shape (or closed annular shape) represented by the 3D point cloud.

Further, one or more embodiments discussed herein can enable detection of large gaps in a path of a 3D point cloud representing an annular shape. For example, a 3D point cloud can comprise several points or nodes such that gaps between certain pairs of the points may not fall in a path describing the annular shape represented by the 3D point cloud. That is, some gaps between pairs of point may not be indicative that a 3D point cloud does not represent a closed ring shape. These gaps can be described as false (or fake) gaps in comparison to real gaps, wherein the real gaps can indicated that a 3D point cloud does not represent a closed ring shape. Detection of false gaps can be challenging due to density of nodes in a 3D point cloud. Accordingly, one or more embodiments discussed herein can enable constructing a graph based on distance between nodes of the 3D point cloud such that large gaps existing in the path of a ring (or annular shape) represented by the 3D point cloud can be distinguished from false gaps, as described herein. Thus, if there is a large gap in the main path of the ring, it can indicate that a graph is not closed and there is no cycle path in the graph.

It is to be appreciated that one or more embodiments discussed herein are not limited to specific domains such as the medical domain. One or more embodiments discussed herein can enable representing nodes of a 3D point cloud by a complete undirected graph, downsample the complete undirected graph to simplify an annular shape represented by the graph and detect whether the annular shape is a closed ring shape based on cycle basis. Advantages of the one or more embodiments discussed herein comprise efficient identification and interpretation of irregular, sparse ring-shaped 3D point clouds, gauging the connectivity of ring-shaped 3D point clouds, and finding a minimum cycle path that can describe an annular shape of the ring-shaped 3D point cloud. As discussed in one or more embodiments herein, a closed ring can mean that a 3D point cloud forms a continuous closed contour in 3D space that can be represented by an undirected graph. Further, an undirected graph, as illustrated and described in one or more embodiments herein, is a graph comprising a set of nodes that are connected by bidirectional edges. Thus, one or more embodiments discussed herein can enable transforming a problem of detecting a closed ring in a 3D point cloud into a problem of finding a long cycle path in an undirected graph.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

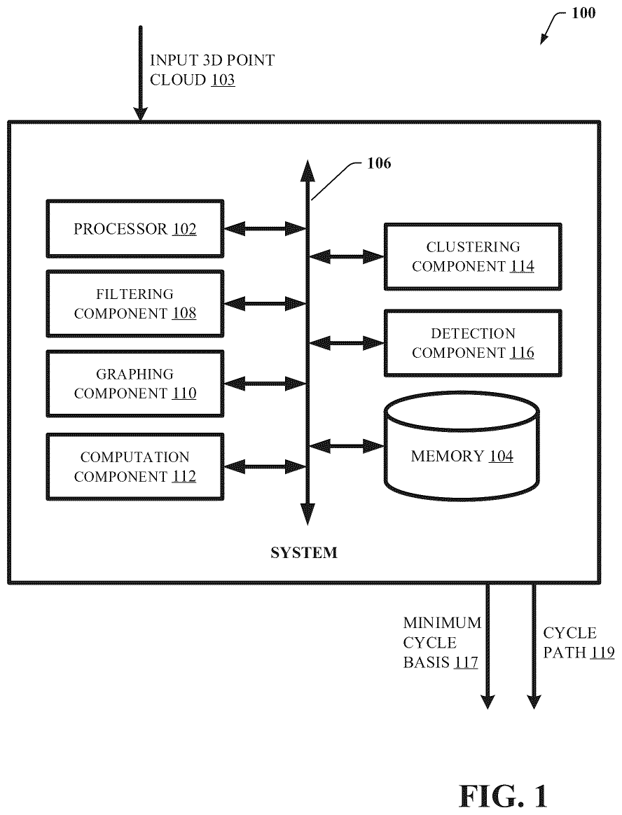

FIG. 1 illustrates a block diagram of an example, non-limiting system that can detect a closed ring in a 3D point cloud via cycle basis in accordance with one or more embodiments described herein. System 100 can comprise processor 102, memory 104, system bus 106, filtering component 108, graphing component 110, computation component 112, clustering component 114, detection component 116.

Discussion first turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., filtering component 108, graphing component 110, computation component 112, clustering component 114, and/or detection component 116) to perform one or more actions. In one or more embodiments, memory 104 can store computer-executable components (e.g., filtering component 108, graphing component 110, computation component 112, clustering component 114, and/or detection component 116).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

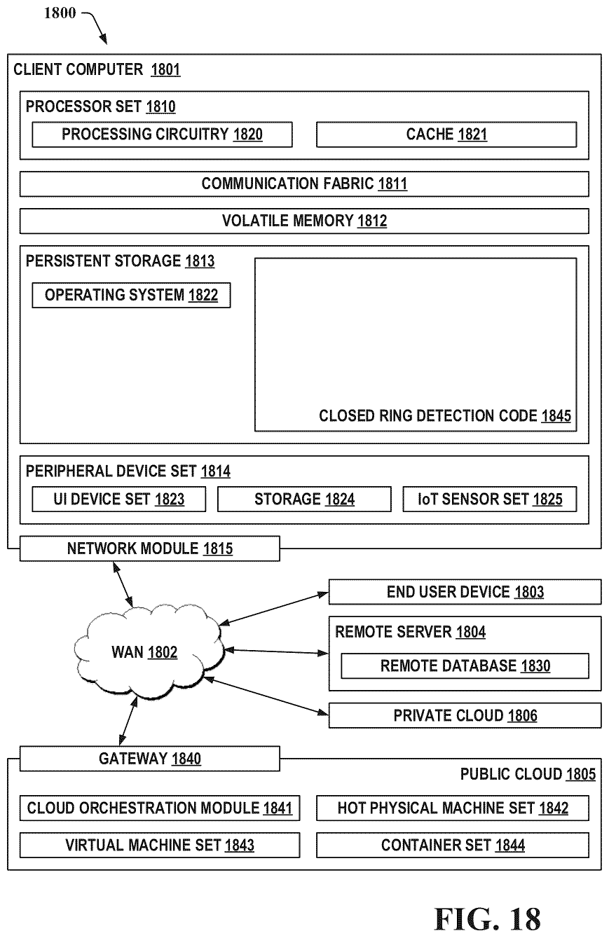

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). System 100 can be associated with, such as accessible via, a computing environment 1800 described below with reference to FIG. 18. For example, system 100 can be associated with a computing environment 1800 such that aspects of processing can be distributed between system 100 and the computing environment 1800.

In one or more embodiments, filtering component 108 of system 100 can employ at least one of voxel downsampling or radius filtering to reduce density of input 3D point cloud 103 to produce a 3D point cloud that is less dense than input 3D point cloud 103. Graphing component 110 can generate a first undirected graph of the 3D point cloud generated by filtering input 3D point cloud 103, wherein graphing component 110 can allocate individual distances between individual nodes of the first undirected graph as edge weights of respective edges connecting the individual nodes. Thereafter, filtering component 108 can filter the first undirected graph by eliminating one or more edges of the first undirected graph that are longer than an adaptive threshold, wherein filtering the first undirected graph produces a second undirected graph. Herein, the adaptive threshold can be defined as being equal to a distance between a first pair of nodes comprised in a first cluster of the first undirected graph such that an edge connecting the first pair of nodes can be longer than a first defined threshold. Herein, the first cluster can be defined such that an average value of individual edge distances of respective individual edges comprised in the first cluster is smaller than a second defined threshold, and wherein the average value of individual edge distances is computed by computation component 112.

In one or more embodiments, clustering component 114 can perform clustering on a plurality of edges of the first undirected graph to generate one or more clusters comprising at least the first cluster, wherein the clustering can be performed based on individual edge distances of the plurality of edges. Further, the clustering can be performed such that a quantity of clusters can be half of a quantity of a first plurality of nodes in the first undirected graph, and wherein the clustering can be performed using machine learning algorithms such as K-nearest neighbors (KNN). Thus, upon downsampling of input 3D point cloud 103 by filtering component 108, a 3D point cloud can be generated, and graphing component 110 can generate a complete undirected graph (e.g., first undirected graph) of the 3D point cloud. Clustering component 114 can cluster the edges comprised in the complete undirected graph (e.g., first undirected graph) to generate multiple clusters such that individual clusters of the multiple clusters can comprise one or more edges. Computation component 112 can calculate an average value for the individual clusters based on distances of individual edges comprised in each cluster, and a cluster (e.g., first cluster) with the smallest average value can be identified. An edge comprised in the cluster (e.g., first cluster) with the smallest average value, whose length is the longest of all edges comprised in the cluster (e.g., first cluster), can be selected as an adaptive threshold.

Thereafter, filtering component 108 can filter the complete undirected graph (e.g., first undirected graph) by eliminating all edges longer than the adaptive threshold. The resultant graph can be a second undirected graph, and detection component 116 can detect minimum cycle basis 117 of the second undirected graph to determine cycle path 119 that can traverse an irregular annular shape that is represented by the 3D point cloud. That is, based on detection of minimum cycle basis 117 in the second undirected graph by detection component 116, a cycle path (e.g., cycle path 119) identifying an irregular annular shape represented by the 3D point cloud can be detected. Detection component 116 can detect cycle path 119 based on minimum cycle basis 117 such that cycle path 119 can have a length greater than respective lengths of individual cycles of minimum cycle basis 117. Detection component 116 can further detect whether cycle path 119 traverses all nodes in the second undirected graph, to determine whether the irregular annular shape can be a closed ring shape.

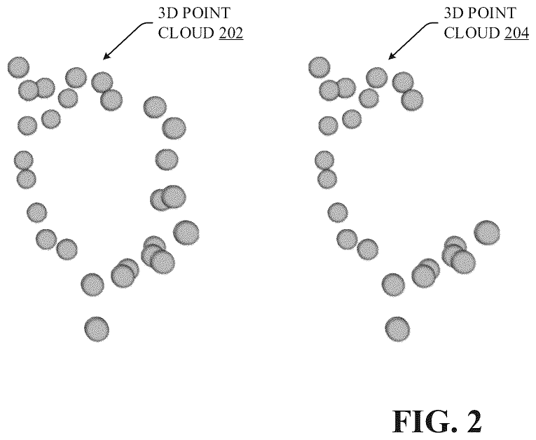

FIG. 2 illustrates example, non-limiting 3D point clouds in accordance with one or more embodiments described herein. Repetitive description of like elements and/or processes employed in respective embodiments is omitted for sake of brevity.

As discussed in one or more embodiments herein, system 100 (FIG. 1) can detect whether a 3D point cloud represents an annular shape that is closed. For example, 3D point cloud 202 can represent a closed ring or a closed annular shape that can be detected by system 100. For example, 3D point cloud 204 can represent an open ring (i.e., an annular shape with a large gap along the main path of the annular shape) that can be detected by system 100.

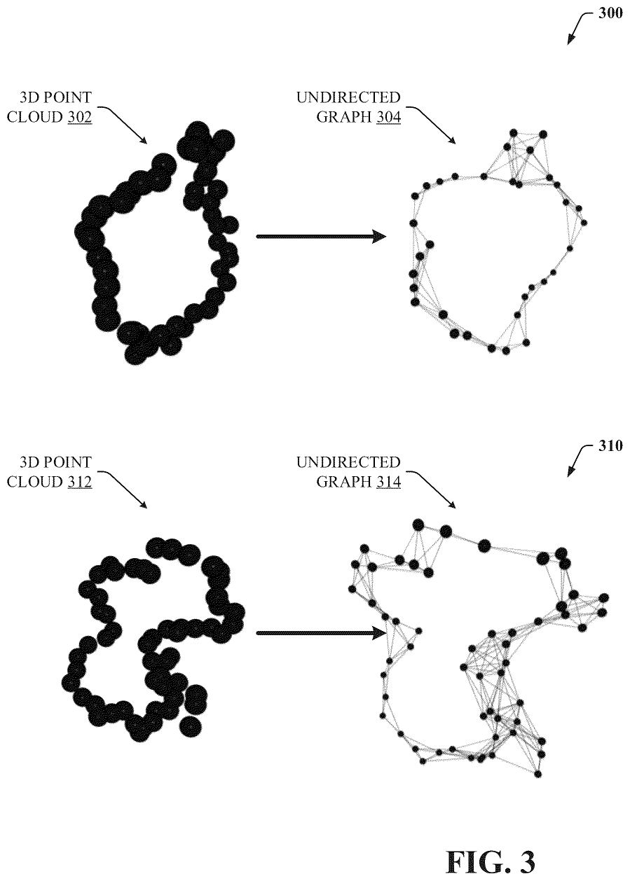

FIG. 3 illustrates example, non-limiting 3D point clouds and their corresponding undirected graphs in accordance with one or more embodiments described herein. Repetitive description of like elements and/or processes employed in respective embodiments is omitted for sake of brevity.

As discussed in one or more embodiments herein, system 100 (FIG. 1) can detect whether a 3D point cloud represents a closed annular shape by representing the 3D point cloud as an undirected graph. For example, at 300, filtering component 108 of system 100 can filter a complete undirected graph (e.g., first undirect graph) of 3D point cloud 302 to generate undirected graph 304 representing 3D point cloud 302, wherein 3D point cloud 302 can be generated by downsampling a 3D point cloud (e.g., input 3D point cloud 103). Thereafter, detection component 116 of system 100 can detect a cycle path (e.g., cycle path 119) in undirected graph 304 that is unaffected by folds or distortions that can be present in 3D point cloud 302 to enable identification of a closed annular shape that can be represented by 3D point cloud 302.

For example, at 310, filtering component 108 of system 100 can filter a complete undirected graph (e.g., first undirect graph) of 3D point cloud 312 to generate undirected graph 314 representing 3D point cloud 312, wherein 3D point cloud 312 can be generated by downsampling a 3D point cloud (e.g., input 3D point cloud 103). Thereafter, detection component 116 of system 100 can detect a cycle path (e.g., cycle path 119) in undirected graph 314 that is unaffected by folds or distortions that can be present in 3D point cloud 312 to enable identification of a closed annular shape that can be represented by 3D point cloud 312.

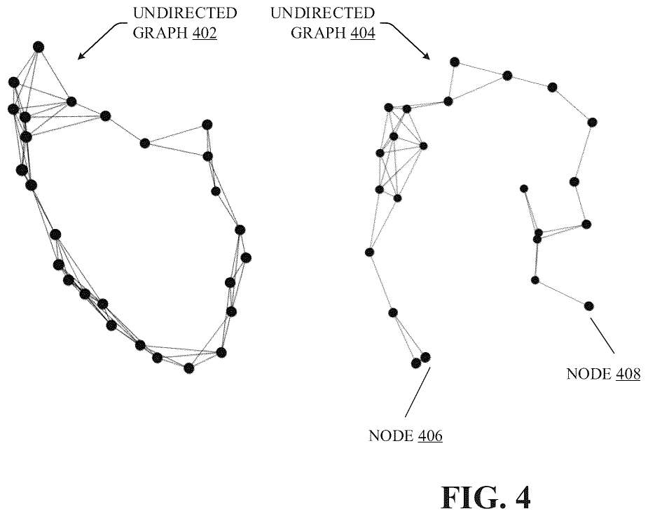

FIG. 4 illustrates example, non-limiting undirected graphs generated from 3D point clouds in accordance with one or more embodiments described herein. Repetitive description of like elements and/or processes employed in respective embodiments is omitted for sake of brevity.

As discussed in one or more embodiments herein, system 100 (FIG. 1) can detect whether a 3D point cloud represents an annular shape that is closed, by detecting large gaps that can be present along the main path of the annular shape. For example, in one or more embodiments discussed herein, filtering component 108 of system 100 can filter a complete undirected graph (e.g., first undirected graph) of a 3D point cloud to generate undirected graph 402 representing the 3D point cloud. Herein, the complete undirected graph of the 3D point cloud can be generated (e.g., by graphing component 110 of system 100) based on spatial distance between individual nodes of the 3D point cloud. Thus, presence of gaps larger than a threshold can be detected in undirected graph 402. For example, detection component 116 of system 100 can detect that individual nodes of undirected graph 402, along the main path of an annular shape represented by undirected graph 402, are separated by a distance less than or equal to an adaptive threshold. Thus, it can imply that undirected graph 402 represents a closed annular shape.

For example, in one or more other embodiments discussed herein, filtering component 108 of system 100 can filter a complete undirected graph (e.g., first undirected graph) of a different 3D point cloud to generate undirected graph 404 representing the different 3D point cloud. Herein, the complete undirected graph of the different 3D point cloud can be generated (e.g., by graphing component 110 of system 100) based on spatial distance between individual nodes of the different 3D point cloud. Thus, presence of gaps larger than a threshold can be detected in undirected graph 402. For example, detection component 116 of system 100 can detect that a distance between node 406 and node 408 of undirected graph 404 is larger than an adaptive threshold. Thus, it can imply that undirected graph 404 comprises a gap (e.g., real gap) in the main path of an annular shape represented by undirected graph 404, further implying that undirected graph 404 does not represent a closed annular shape.

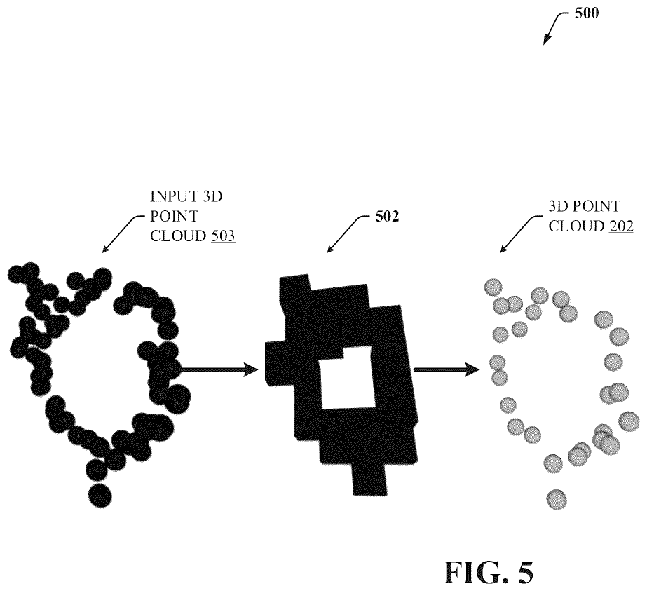

FIG. 5 illustrates an example, non-limiting process 500 of downsampling a 3D point cloud in accordance with one or more embodiments described herein. Repetitive description of like elements and/or processes employed in respective embodiments is omitted for sake of brevity.

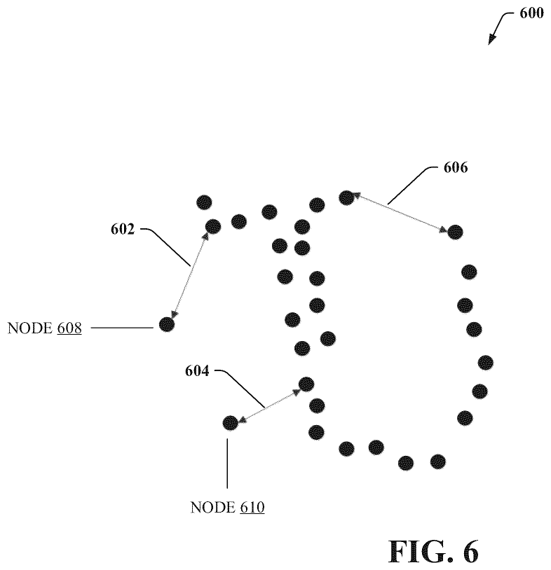

In one or more embodiments discussed herein, input 3D point cloud 503 can be downsampled, at 502, by filtering component 108 of system 100 (FIG. 1). Filtering component 108 can use at least one of voxel downsampling or radius filtering to downsample input 3D point cloud 503. Input 3D point cloud 503 can be downsampled to reduce density of input 3D point cloud 503 and eliminate interference that can be caused by the presence of unnecessary nodes in input 3D point cloud 503. As a result of downsampling input 3D point cloud 503, 3D point cloud 202 (FIG. 2) can be generated and further analyzed to detect a closed annular shape, in accordance with one or more embodiments discussed herein. As a result of downsampling input 3D point cloud 503, 3D point cloud 204 of FIG. 2 (not pictured) can be generated and further analyzed to detect an open annular shape, in accordance with one or more other embodiments discussed herein. Downsampling 3D point cloud 503 can cause an even reduction in the density of 3D point cloud 503 such that an original shape of a ring represented (or modeled) by 3D point cloud 503 can be retained. Further, downsampling a 3D point cloud can enable system 100 to detect the presence of real gaps and fake gaps in the resultant 3D point cloud. This concept has been further illustrated in FIG. 6.

FIG. 6 illustrates an example, non-limiting 3D point cloud representing an open ring shape in accordance with one or more embodiments described herein. Repetitive description of like elements and/or processes employed in respective embodiments is omitted for sake of brevity.

3D point cloud 600 can represent an annular shape that is not closed (i.e., an open ring shape or an open annular shape). 3D point cloud 600 can be generated by downsampling (e.g., by filtering component 108 of FIG. 1) an input 3D point cloud (e.g., input 3D point cloud 103 of FIG. 1). Graphing component 110 (FIG. 1) can generate a complete undirected graph (e.g., first undirected graph) of 3D point cloud 600 based on spatial distances between individual nodes of 3D point cloud 600 such that graphing component 110 can allocate individual distances between the individual nodes of the complete undirected graph as edge weights of respective edges connecting the individual nodes. Thereafter, filtering component 108 can filter the complete undirected graph to generate a second undirected graph and detection component 116 can detect a cycle path (e.g., cycle path 119) in the second undirected graph to identify whether 3D point cloud 600 represents a closed ring shape.

One of the challenges with detecting the cycle path (e.g., cycle path 119) can be the detection of real gaps. Real gaps can be described as gaps between individual nodes of the second undirected graph, along a cycle path (e.g., cycle path 119) representing an annular shape, that are longer than an adaptive threshold. Presence of one or more real gaps can imply that 3D point cloud 600 does not represent a closed annular shape. For example, real gap 606 can be present in 3D point cloud 600, indicating that 3D point cloud 600 does not represent a closed annular shape. Contrarily, fake gaps can be described as gaps between individual nodes of the second undirected graph that are longer than an adaptive threshold, wherein the gaps occur outside of the cycle path (e.g., cycle path 119) representing the annular shape. Presence of one or more fake gaps may not be enough to indicate whether 3D point cloud 600 represents an open annular shape. For example, node 608 and node 610 can respectively cause fake gap 602 and fake gap 604 to occur in 3D point cloud 600, wherein fake gap 602 and fake gap 604 can occur outside of the main path of an annular shape represented by 3D point cloud 600.

Thus, detecting a cycle path (e.g., cycle path 119) representing an annular shape can be challenging. Only real gaps can indicate that an annular shape represented by 3D point cloud 600 is not closed, the adjacent relationship between nodes can be unknown, and isolated points (e.g., node 608 and node 610) and the respective gaps (e.g., fake gap 602 and fake gap 604) can go undistinguished. It can be considered that an adjacent relationship exists between individual nodes or points of 3D point cloud 600 such that a complete undirected graph (e.g., first undirected graph) of 3D point cloud 600 can be constructed (e.g., by graphing component 110 of FIG. 1) based on spatial distances between the individual nodes or points. The complete undirected graph (e.g., first undirected graph) can be filtered (e.g., by filtering component 108 of FIG. 1) by eliminating edges that are longer than an adaptive threshold to generate the second undirected graph as discussed in one or more embodiments herein. The second undirected graph can represent an even distribution of the nodes or points of 3D point cloud 600 along a cycle path (e.g., cycle path 119), and fake gaps caused by node 608 and node 610 can be clearly distinguished from real gap 606.

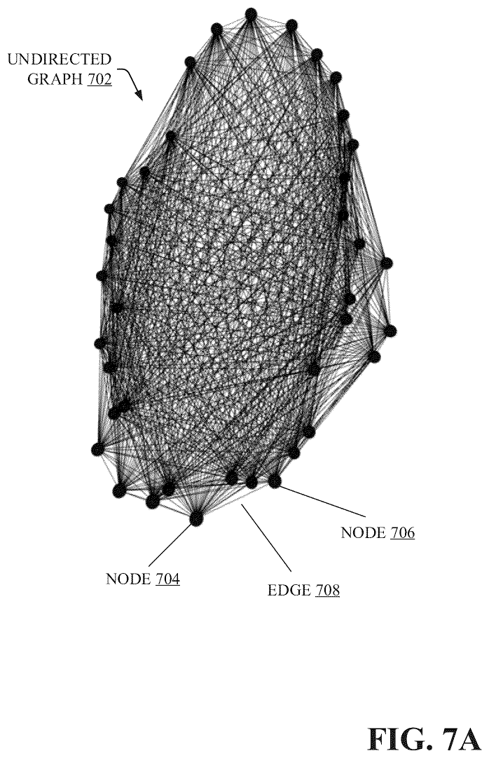

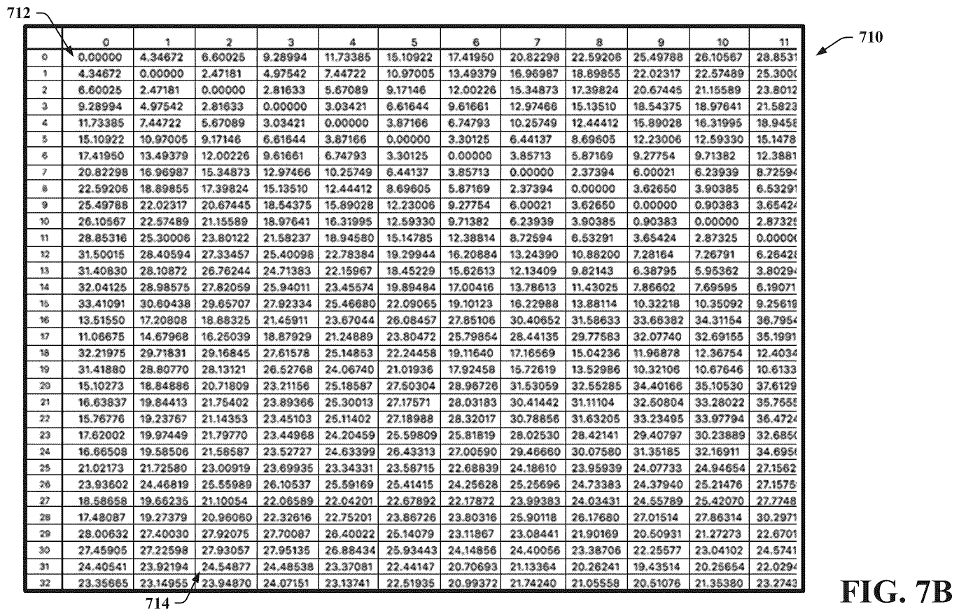

FIG. 7A illustrates an example, non-limiting complete undirected graph of a 3D point cloud in accordance with one or more embodiments described herein. Repetitive description of like elements and/or processes employed in respective embodiments is omitted for sake of brevity.

Undirected graph 702 can represent a complete undirected graph (e.g., first undirected graph) that can be constructed by graphing component 110 (FIG. 1) based on a 3D point cloud representing an annular shape, wherein the annular shape can be irregular, and wherein the annular shape can be a closed ring or an open ring as discussed in one or more embodiments herein. Graphing component 110 can generate undirected graph 702 based on spatial distances between individual nodes of the 3D point cloud such that graphing component 110 can allocate individual distances between the individual nodes of the complete undirected graph as edge weights of respective edges connecting the individual nodes. For example, edge 708 of undirected graph 702 can connect node 704 and node 706 of undirected graph 702 and a distance between node 704 and node 706 can be allocated as the edge weight of edge 708.

FIG. 7B illustrates an example, non-limiting table 710 comprising edge distances for the undirected graph of FIG. 7A in accordance with one or more embodiments described herein. Repetitive description of like elements and/or processes employed in respective embodiments is omitted for sake of brevity.

Table 710 illustrates a matrix showing distances between individual nodes of undirected graph 702. Numbers 0-11 in the topmost row of table 710 and numbers 0-32 in the leftmost column of table 710 can represent the various nodes of undirected graph 702. For example, number 0 can represent node 704 of undirected graph 702. For example, the distance of 0.00000 units in graph space at cell 712 of table 710 can indicate a distance between the point 0 (e.g., node 704) and itself (e.g., node 704) of undirected graph 702, whereas the distance of 24.54877 units in graph space at cell 714 of table 710 can indicate a distance between point 31 and point 2 of undirected graph 702.

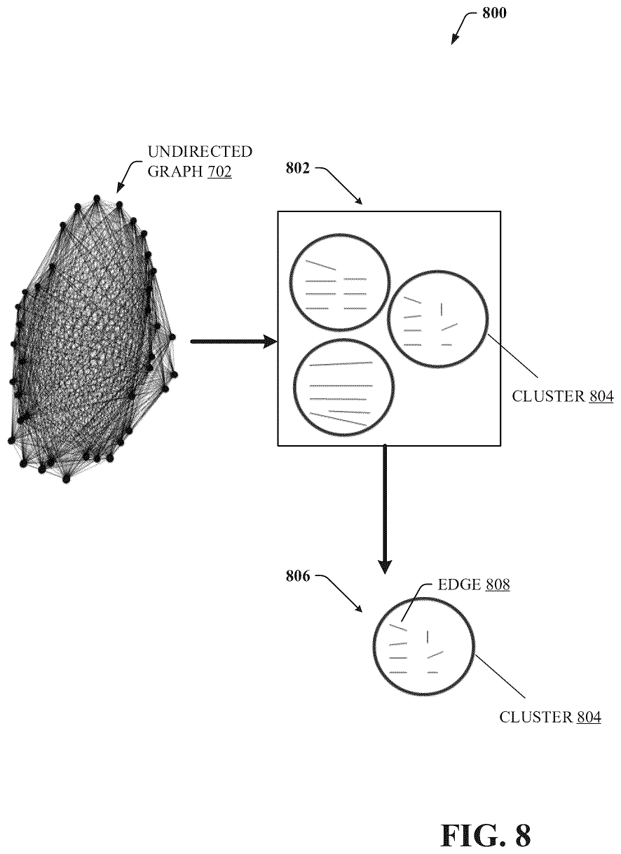

FIG. 8 illustrates an example, non-limiting process 800 of identifying an adaptive threshold for filtering the complete undirected graph of FIG. 7A in accordance with one or more embodiments described herein. Repetitive description of like elements and/or processes employed in respective embodiments is omitted for sake of brevity.

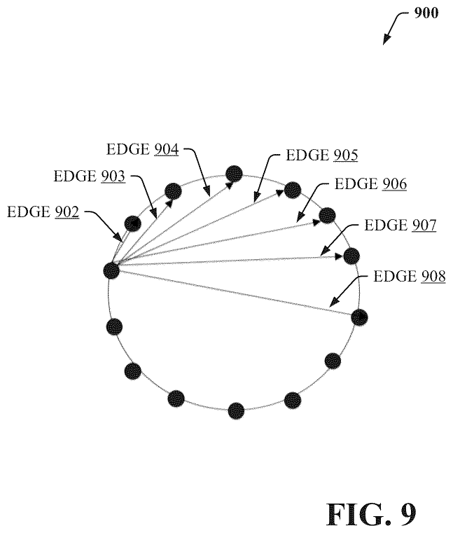

At 802, clustering component 114 can perform clustering on a plurality of edges of undirected graph 702 to generate a plurality of clusters and identify an adaptive threshold distance (e.g., adaptive distance K) such that undirected graph 702 can be filtered to eliminate edges that are longer than the adaptive threshold distance. The clustering can be performed based on distances of individual edges of the plurality of edges of undirected graph 702 (e.g., distances listed in table 710) by using machine learning algorithms including, but not limited to, K-nearest neighbors (KNN). The clustering can be performed such that a quantity of clusters can be half of a quantity of a first plurality of nodes in the first undirected graph. This concept has been discussed in greater detail in FIG. 9.

The one or more clusters generated as a result of clustering the plurality of edges of undirected graph 702 can comprise cluster 804 wherein cluster 804 can comprise the smallest edge out of the plurality of edges of undirected graph 702. As such, an average value for cluster 804, calculated by computation component 112 based on averaging individual distances of respective individual edges comprised in cluster 804, can be smaller than average values similarly calculated by computation component 112 for the remaining clusters generated at 802. That is, computation component 112 can calculate individual average values for respective individual clusters generated at 802, wherein an average value for a cluster can be calculated by averaging the distances of individual edges comprised in the respective cluster. Cluster 804 can have the smallest average value and edge 808 can be longer than other edges comprised in cluster 804 such that the distance represented by edge 808 can be selected, at 806, as the adaptive threshold to filter undirected graph 702. That is, cluster 804 is likely to represent an average distance (near step) between neighboring nodes of undirected graph 702.

FIG. 9 illustrates an example, non-limiting embodiment of a 3D point cloud in accordance with one or more embodiments described herein. Repetitive description of like elements and/or processes employed in respective embodiments is omitted for sake of brevity.

Graph 900 illustrates an aspect of clustering edges of an undirected graph such that a number of clusters generated as a result of the clustering can be half the number of nodes of the undirected graph, as discussed in one or more embodiments herein. For example, graph 900 can be an undirected graph of a circular shaped ring comprising 14 nodes, and graph 900 can have about seven different types of distances as illustrated by edges 902-908 (i.e., edge 902, edge 903, edge 904, edge 905, edge 906, edge 907 and edge 908). The total number of edges comprised in graph 900 can be clustered around the seven different distances such that seven clusters can be generated, wherein the individual clusters can comprise one or more edges of graph 900. Thus, it can be concluded that the edges of an undirected graph of a 3D point cloud can be clustered such that the number of resultant clusters can be half the number of nodes of the undirected graph. As such, edges of undirected graph 702 (FIG. 7A) can be clustered at 802 (FIG. 8) to form the different clusters.

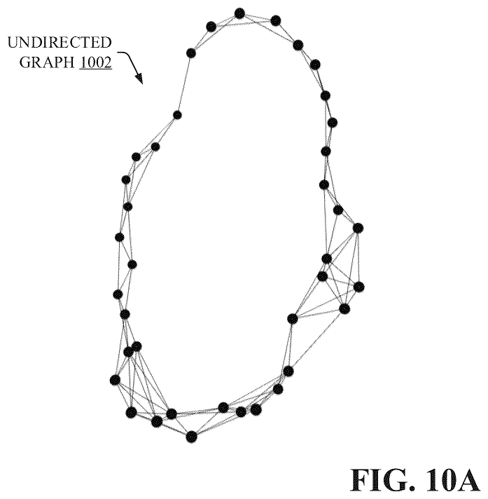

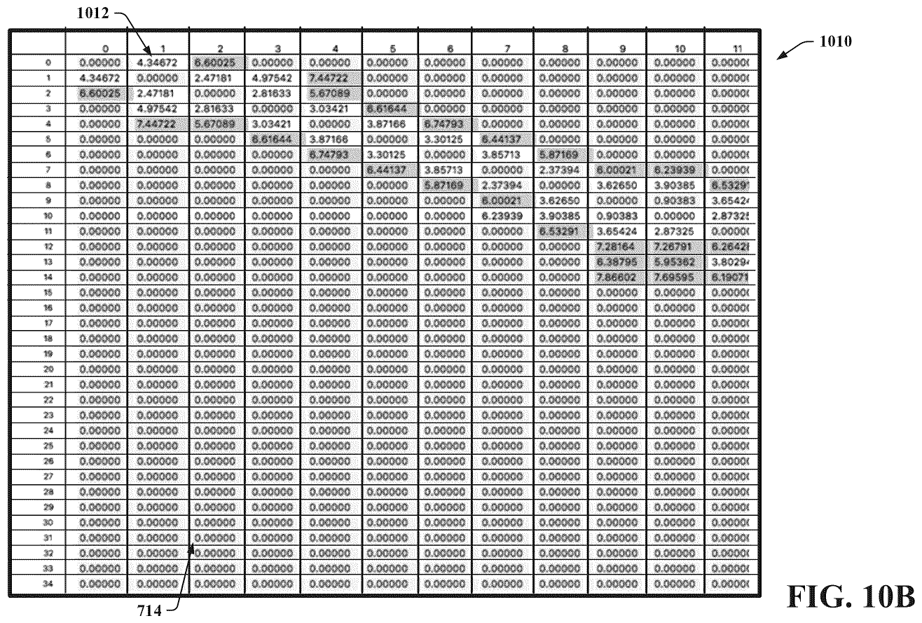

FIG. 10A illustrates an example, non-limiting undirected graph 1002 in accordance with one or more embodiments described herein. Repetitive description of like elements and/or processes employed in respective embodiments is omitted for sake of brevity.

As discussed in one or more embodiments herein, undirected graph 1002 can be generated by filtering undirected graph 702 (FIG. 7A) by filtering component 108 (FIG. 1), wherein filtering component 108 can filter undirected graph 702 by eliminating edges longer than the adaptive threshold, and wherein the adaptive threshold can be equal to a distance represented by edge 808 (FIG. 8).

FIG. 10B illustrates an example, non-limiting table 1010 comprising edge distances for the undirected graph of FIG. 10A in accordance with one or more embodiments described herein. Repetitive description of like elements and/or processes employed in respective embodiments is omitted for sake of brevity.

Table 1010 illustrates a matrix showing distances between individual nodes of undirected graph 1002. Numbers 0-11 in the topmost row of table 1010 and numbers 0-34 in the leftmost column of table 1010 can represent the various nodes of undirected graph 1002. Since undirected graph 1002 can result from filtering undirected graph 702 (FIG. 7), table 1010 can be described as resulting from table 710. Since several edges of undirected graph 702 can be eliminated after the filtering, table 1010 illustrates several of the previously populated cells of table 710 as having a distance of 0.00000 units. For example, a distance of 24.54877 units in cell 714 of table 710 can become 0.00000 as illustrated in table 1010. For example, a distance of 4.34672 units in cell 1012 can remain unchanged from the value listed in the equivalent cell of table 710 if an edge associated with the respective distance is not eliminated as a result of having a distance less than or equal to the adaptive threshold.

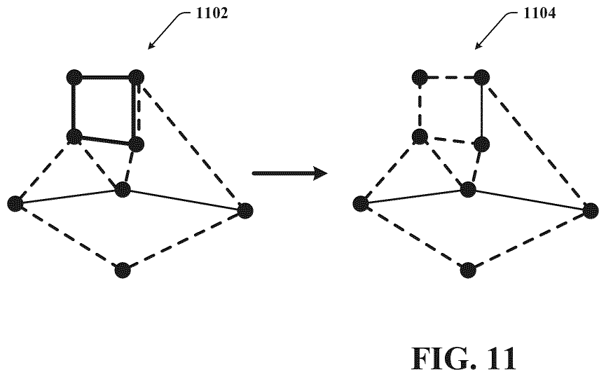

FIG. 11 illustrates example, non-limiting cycle basis in an undirected graph of a 3D point cloud in accordance with one or more embodiments described herein. Repetitive description of like elements and/or processes employed in respective embodiments is omitted for sake of brevity.

As discussed in one or more embodiments herein, detection component 116 (FIG. 1) can detect a cycle path (e.g., cycle path 119) in an undirected graph (e.g., undirected graph 1002 of FIG. 10A) of a 3D point cloud based on detection of a minimum cycle basis (e.g., minimum cycle basis 117) such that the cycle path can have a length greater than respective lengths of individual cycles of the minimum cycle basis. A minimum cycle basis (e.g., minimum cycle basis 117) for cycles of a network (e.g., undirected graph 1002) can be described as a minimum collection of cycles such that any cycle in the network can be written as a sum of cycles in the basis. For example, a cycle illustrated as the loop formed by the dashed lines in graph 1104 can be described as a symmetric difference of the cycle illustrated by the loop formed by the thick sold lines and the cycle illustrated by the loop formed by the dashed lines in graph 1102. A minimum cycle basis (e.g., minimum cycle basis 117) can be detected (or calculated) by using algorithms.

For example, a cycle basis algorithm wherein input parameters specifying the graph and a starting node (or root node) in the graph can yield a list of cycles that form a basis for cycles of a graph P, wherein an individual cycle list comprises a list of nodes that can form the cycle in graph P. For example, a simple cycles algorithm that can find simple cycles (elementary circuits) of a graph P to calculate a closed ring in graph P can be used, wherein input parameters specifying a graph P can yield a list of nodes wherein an individual cycle can be represented by a list of nodes along the cycle. For example, a minimum cycle basis algorithm that can return a minimum weight cycle basis for a graph P to detect minimum cycle basis in a graph P can be used, wherein input parameters specifying the graph and edge weight information can yield a list of cycles wherein an individual cycle list comprises a list of nodes that can form the cycle in graph P. For example, a non-recursive version of a recursive simple cycle algorithm that can find simple cycles of a graph P can be used, wherein input parameters of a graph P can yield a list of cycles.

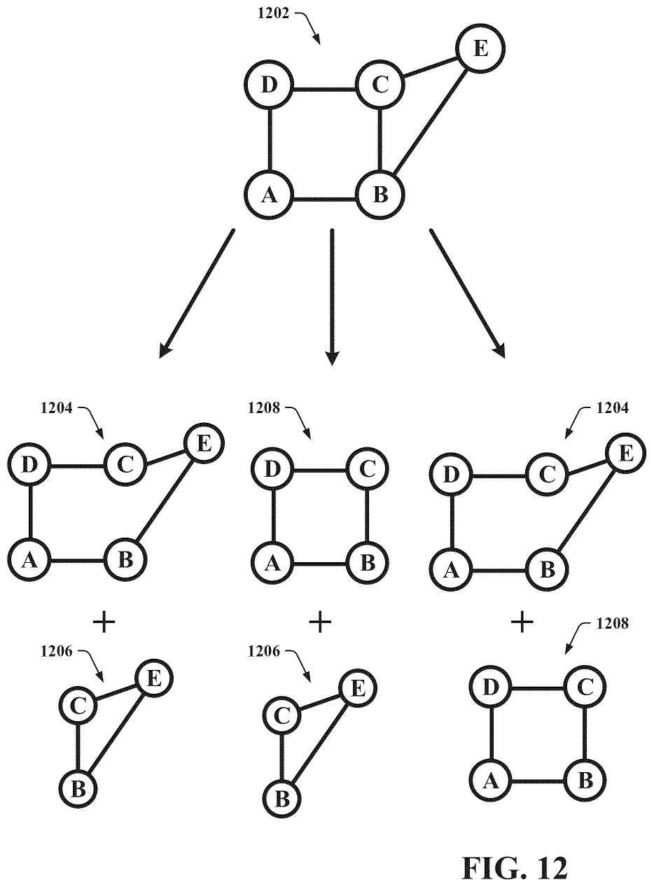

The graphs in FIG. 11 can be described with 64 basic cycles wherein individual numbers indicate individual nodes (e.g., [[16, 17, 37], . . . , [1, 4, 5, 7, 8, 11, 14, 15, 35, 36, 33, 32, 27, 28, 24, 22, 20, 17, 37, 0], [1, 2, 0]]). The concept of cycle basis has been further illustrated in FIG. 12.

FIG. 12 illustrates an example, non-limiting set of simple cycles that can be found in an undirected graph in accordance with one or more embodiments described herein. Repetitive description of like elements and/or processes employed in respective embodiments is omitted for sake of brevity.

Graph 1202 can be an undirected graph formed of nodes A— E, and graph 1202 can be expressed as a summation of simple cycles 1204 and 1208, wherein simple cycles 1204, 1206, and 1208 can be the smallest cycles in the graph. Any cycles can be calculated by summation of the simple cycles. That is, once the smallest cycles can be calculated for an undirected graph based on detection of minimum cycle basis (e.g., minimum cycle basis 117), a long list of cycle paths can be generated, and the longest cycle path can be selected as a cycle path (e.g., cycle path 119) that is likely to represent an annular shape of the undirected graph.

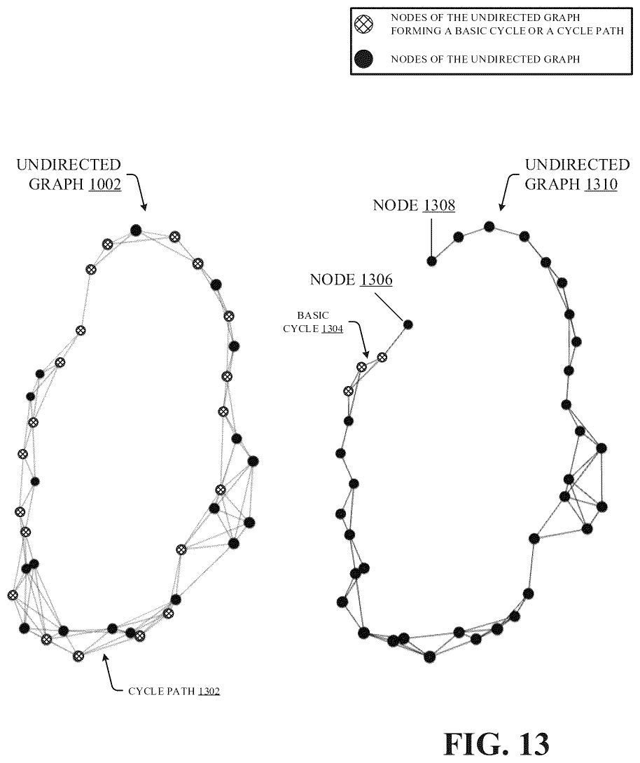

FIG. 13 illustrates example, non-limiting cycle paths that can be found in an undirected graph of a 3D point cloud in accordance with one or more embodiments described herein. Repetitive description of like elements and/or processes employed in respective embodiments is omitted for sake of brevity.

As discussed in one or more embodiments herein, detection component 116 can detect a minimum cycle basis (e.g., minimum cycle basis 117) for undirected graph 1002 (FIG. 10A) to detect whether undirected graph 1002 represents a closed annular shape or a closed ring shape. For example, detection component 116 can detect cycle path 1302, illustrated by the hash-filled circles in undirected graph 1002, such that cycle path 1302 can represent a closed annular shape. Cycle path 1302 can be detected based on calculation of a minimum cycle basis (e.g., minimum cycle basis 117) comprising simple cycles.

For example, a long list of cycle paths can be generated for undirected graph 1002 based on detection of minimum cycle basis (e.g., minimum cycle basis 117), and the longest cycle path can be selected as a proposal path (e.g., cycle path 1302, cycle path 119) that can describe an annular shape, wherein nodes of the proposal path can likely traverse undirected graph 1002. If the length of the proposal path is less than a certain length (e.g., <m) it can represent a closed ring. It is to be appreciated that in one or more embodiments, a hash-filled circle represents nodes of the undirected graph that form a basic cycle (e.g., simple cycle) or a cycle path (e.g., proposal path) and a solid-filled circle represents individual nodes of the undirected graph, as also illustrated by the legends in some of the figures.

In one or more other embodiments, in an undirected graph 1310 of a 3D point cloud, node 1306 and node 1308 can be separated by a distance greater than an adaptive threshold (e.g., adaptive threshold defined by edge 808 of FIG. 8) such that undirected graph 1310 can represent an open annular shape. Detection component 116 can detect a cycle path (e.g., cycle path 1302, cycle path 119) in undirected graph 1310 based on detection of a minimum cycle basis (e.g., minimum cycle basis 117) comprising simple cycles such as basic cycle 1304 which illustrates a triangle shaped simple cycle.

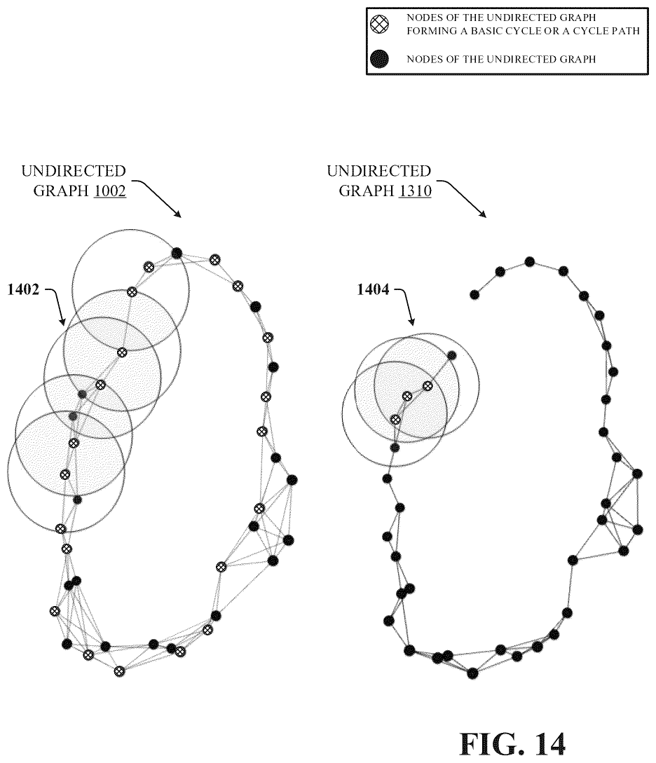

FIG. 14 further illustrates example, non-limiting cycle paths that can be found in an undirected graph of a 3D point cloud in accordance with one or more embodiments described herein. Repetitive description of like elements and/or processes employed in respective embodiments is omitted for sake of brevity.

As discussed in one or more embodiments herein, upon selection of a proposal path for undirected graph 1002 (FIG. 10A), detection component 116 can perform a check to determine whether the proposal path traverses all nodes of undirected graph 1002. For example, at 1402, detection component 116 can perform a check (indicated by the large circles) and determine that a proposal path (e.g., cycle path 1302, cycle path 119) of undirected graph 1002 represents a closed annular shape. In one or more other embodiments, detection component 116 can perform a check (indicated by the large circles) at 1404 and determine that a proposal path (e.g., cycle path) of undirected graph 1310 (FIG. 13) represents an open annular shape. Thus, detection component 116 can perform the checks (e.g., 1402 and 1404) by selecting a node in the proposal path and checking if all nodes adjacent to the selected node have a distance smaller than the adaptive threshold (e.g., adaptive threshold defined by edge 808 of FIG. 8) from the selected node. The checks can be performed for the individual nodes comprising the proposal path to determine whether the proposal path completely traverses undirected graph 1002. In an open ring, the proposal path can only traverse a part of undirected graph 1002 and not the entire undirected graph 1002. The checks can be performed using steps built into an algorithm that can execute one or more embodiments herein.

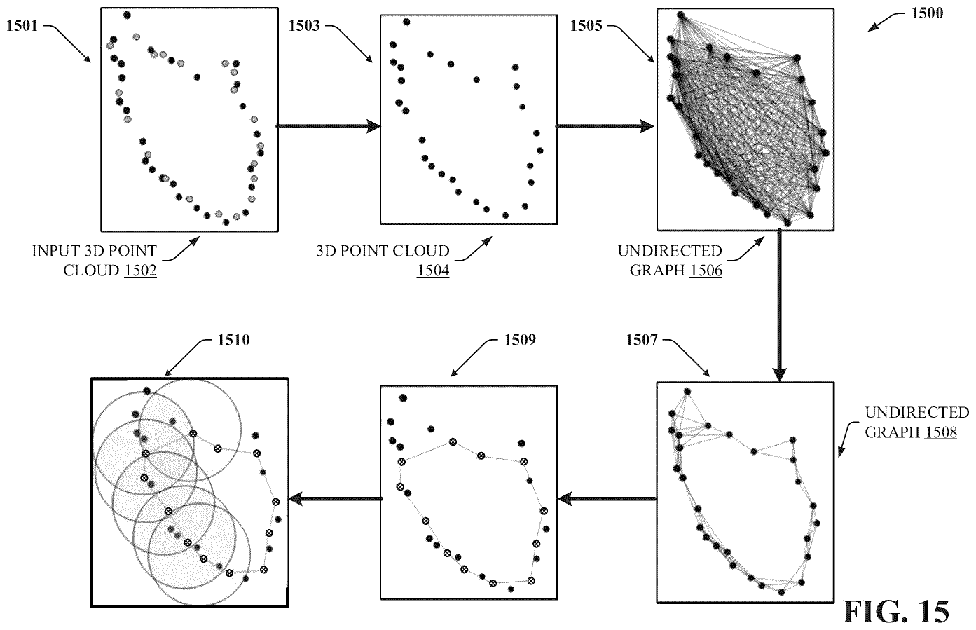

FIG. 15 illustrates a flow diagram of an example, non-limiting method 1500 of detecting a closed ring in a 3D point cloud via cycle basis in accordance with one or more embodiments described herein. Repetitive description of like elements and/or processes employed in respective embodiments is omitted for sake of brevity.

At 1501, an input 3D point cloud 1502 can be input into system 100 (FIG. 1). At 1503, filtering component 108 of system 100 can downsample input 3D point cloud 1502 by employing voxel downsampling or radius filtering to reduce density of input 3D point cloud 1502 and generate 3D point cloud 1504. For example, the solid-filled circles of input cloud 1502 that are of a lighter shade can represent the nodes of input 3D point cloud 1502 that can be eliminated as a result of the downsampling. At 1505, graphing component 110 of system 100 can generate undirected graph 1506 wherein all nodes of 3D point cloud 1502 can be connected via bidirectional edges.

At 1507, filtering component 108 can filter undirected graph 1506 by eliminating one or more edges of undirected graph 1506 that are longer than an adaptive threshold. As discussed in one or more embodiments herein, the adaptive threshold can be determined by clustering the edges of undirected graph 1506, calculating an average value of the individual clusters generated as a result of the clustering, and selecting a distance represented by the longest edge comprised in a cluster with the smallest average value as the adaptive threshold. Filtering undirected graph 1506 can generate undirected graph 1508.

At 1509, detection component 116 of system 100 can detect (or calculate) a minimum cycle basis (e.g., minimum cycle basis 117) for undirected graph 1508. Calculation of the minimum cycle basis (e.g., minimum cycle basis 117) can generate a list of cycle paths that can be present in undirected graph 1508 and the longest cycle path can be selected as a proposal path (illustrated in FIG. 15 as the path formed by connecting the hash-filled circles), wherein the proposal path can represent an annular shape that can be modeled by 3D point cloud 1504. At 1510, detection component 116 can perform a check to determine whether the proposal path traverses all nodes of undirected graph 1508 to conclude whether 3D point cloud 1504 represents a closed annular shape or a closed ring shape.

One or more embodiments described herein, propose a semi-automatic approach to use a computational plane equation to filter walls and floors of a 3D point cloud and provide candidate object via clustering edges of an undirected graph to enable detection of a closed ring shape in the 3D point cloud via cycle basis. It is to be appreciated that in one or more embodiments, a hash-filled circle represents nodes of the undirected graph that form a basic cycle (e.g., simple cycle) or a cycle path (e.g., proposal path) and a solid-filled circle represents individual nodes of the undirected graph, as also illustrated by the legends in some of the figures.

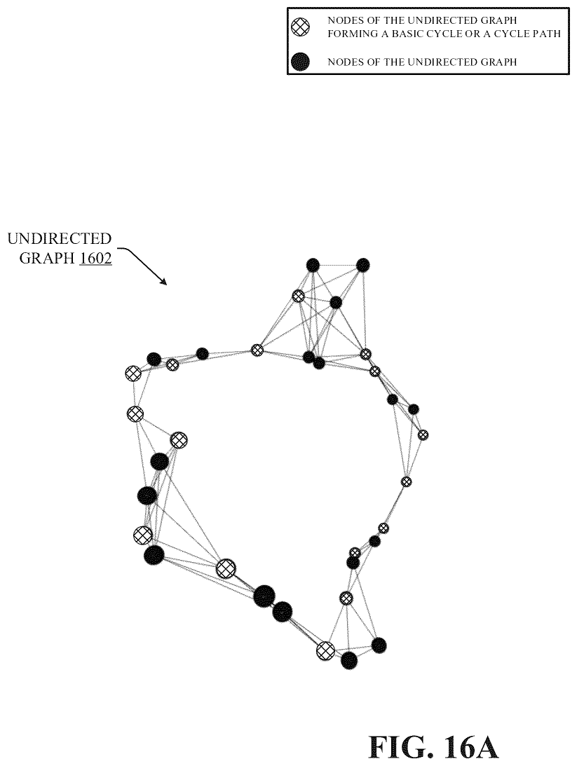

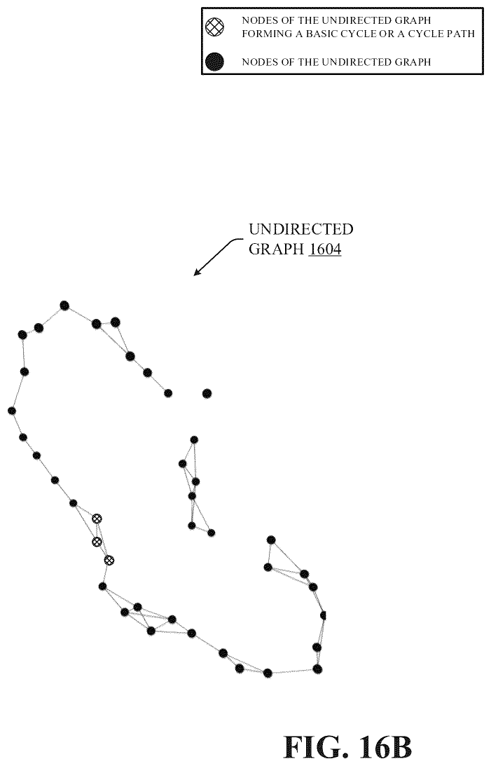

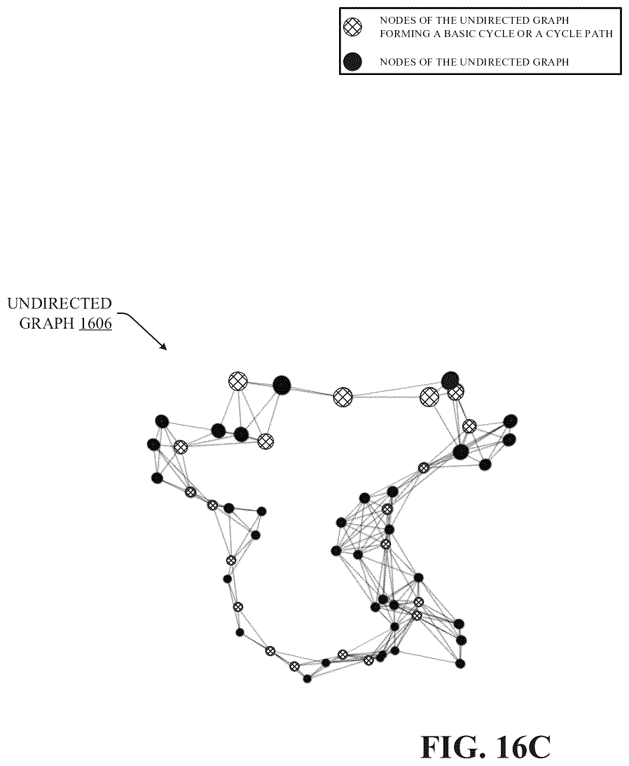

FIG. 16A illustrates an example, non-limiting cycle path represented by an undirected graph of a 3D point cloud in accordance with one or more embodiments described herein. Repetitive description of like elements and/or processes employed in respective embodiments is omitted for sake of brevity.

Undirected graph 1602 can be an undirected graph of a 3D point cloud such that a cycle path (illustrated by the hash-filled circles) detected (or calculated) for undirected graph 1602 can imply that undirected graph 1602 represents a closed annular shape, in accordance with one or more embodiments discussed herein.

FIG. 16B further illustrates an example, non-limiting cycle path represented by an undirected graph of a 3D point cloud in accordance with one or more embodiments described herein. Repetitive description of like elements and/or processes employed in respective embodiments is omitted for sake of brevity.

Undirected graph 1606 can be an undirected graph of a 3D point cloud such that a cycle path (e.g., cycle path 119) detected (or calculated) for undirected graph 1604, based on detection of minimum cycle basis (e.g., minimum cycle basis 117), can imply that undirected graph 1602 represents an open annular shape, in accordance with one or more embodiments discussed herein.

FIG. 16C further illustrates an example, non-limiting cycle path represented by an undirected graph of a 3D point cloud in accordance with one or more embodiments described herein. Repetitive description of like elements and/or processes employed in respective embodiments is omitted for sake of brevity.

Undirected graph 1606 can be an undirected graph of a 3D point cloud such that a cycle path (illustrated by the hash-filled circles) detected (or calculated) for undirected graph 1606 can imply that undirected graph 1606 represents a closed annular shape, in accordance with one or more embodiments discussed herein.

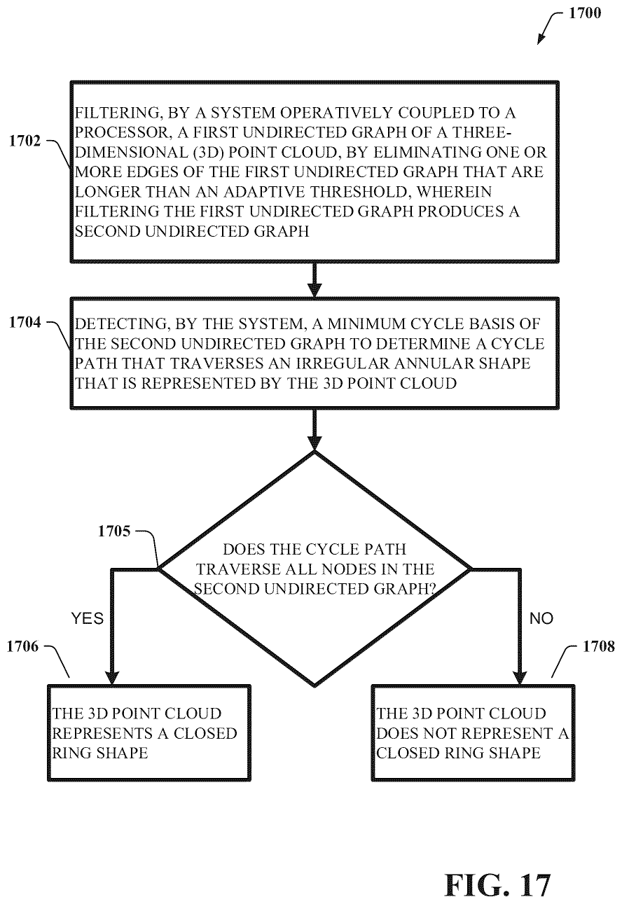

FIG. 17 illustrates a flow diagram of an example, non-limiting method 1700 of detecting a closed ring in a 3D point cloud via cycle basis in accordance with one or more embodiments described herein. Repetitive description of like elements and/or processes employed in respective embodiments is omitted for sake of brevity.

At 1702, the non-limiting method 1700 can comprise filtering (e.g., by filtering component 108), by a system operatively coupled to a processor, a first undirected graph of a 3D point cloud, by eliminating one or more edges of the first undirected graph that are longer than an adaptive threshold, wherein filtering the first undirected graph produces a second undirected graph.

At 1704, the non-limiting method 1700 can comprise detecting (e.g., by detection component 116), by the system, a minimum cycle basis of the second undirected graph to determine a cycle path that traverses an irregular annular shape that is represented by the 3D point cloud.

At 1705, the non-limiting method 1700 can determine if the cycle path traverses all nodes in the second undirected graph. If yes, the non-limiting method 1700 can conclude, at 1706, that the 3D point cloud represents a closed ring shape. If no, the non-limiting method 1700 can conclude, at 1708, that the 3D point cloud does not represent a closed ring shape.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively detect a closed ring shape in a 3D point cloud as the one or more embodiments described herein can enable this process. And, neither can the human mind nor a human with pen and paper detect a closed ring shape in a 3D point cloud, as conducted by one or more embodiments described herein.

FIG. 18 illustrates a block diagram of an example, non-limiting, operating environment in which one or more embodiments described herein can be facilitated. FIG. 18 and the following discussion are intended to provide a general description of a suitable operating environment 1800 in which one or more embodiments described herein at FIGS. 1-17 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1800 contains an example of an environment for the execution of at least some of the computer code involved in performing the inventive methods, such as closed ring detection code 1845. In addition to block 1845, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and block 1845, as identified above), peripheral device set 1814 (including user interface (UI), device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844.

COMPUTER 1801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method may be distributed among multiple computers and/or between multiple locations. On the other hand, in this presentation of computing environment 1800, detailed discussion is focused on a single computer, specifically computer 1801, to keep the presentation as simple as possible. Computer 1801 may be located in a cloud, even though it is not shown in a cloud in FIG. 18. On the other hand, computer 1801 is not required to be in a cloud except to any extent as may be affirmatively indicated.

PROCESSOR SET 1810 includes one, or more, computer processors of any type now known or to be developed in the future. Processing circuitry 1820 may be distributed over multiple packages, for example, multiple, coordinated integrated circuit chips. Processing circuitry 1820 may implement multiple processor threads and/or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set may be located “off chip.” In some computing environments, processor set 1810 may be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1821 and the other storage media discussed below. The program instructions, and associated data, are accessed by processor set 1810 to control and direct performance of the inventive methods. In computing environment 1800, at least some of the instructions for performing the inventive methods may be stored in block 1845 in persistent storage 1813.

COMMUNICATION FABRIC 1811 is the signal conduction paths that allow the various components of computer 1801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1812 is any type of volatile memory now known or to be developed in the future. Examples include dynamic type random access memory (RAM) or static type RAM. Typically, the volatile memory is characterized by random access, but this is not required unless affirmatively indicated. In computer 1801, the volatile memory 1812 is located in a single package and is internal to computer 1801, but, alternatively or additionally, the volatile memory may be distributed over multiple packages and/or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 and/or directly to persistent storage 1813. Persistent storage 1813 may be a read only memory (ROM), but typically at least a portion of the persistent storage allows writing of data, deletion of data and re-writing of data. Some familiar forms of persistent storage include magnetic disks and solid state storage devices. Operating system 1822 may take several forms, such as various known proprietary operating systems or open source Portable Operating System Interface type operating systems that employ a kernel. The code included in block 1845 typically includes at least some of the computer code involved in performing the inventive methods.

PERIPHERAL DEVICE SET 1814 includes the set of peripheral devices of computer 1801. Data communication connections between the peripheral devices and the other components of computer 1801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1823 may include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 may be persistent and/or volatile. In some embodiments, storage 1824 may take the form of a quantum computing storage device for storing data in the form of qubits. In embodiments where computer 1801 is required to have a large amount of storage (for example, where computer 1801 locally stores and manages a large database) then this storage may be provided by peripheral storage devices designed for storing very large amounts of data, such as a storage area network (SAN) that is shared by multiple, geographically distributed computers. IoT sensor set 1825 is made up of sensors that can be used in Internet of Things applications. For example, one sensor may be a thermometer and another sensor may be a motion detector.

NETWORK MODULE 1815 is the collection of computer software, hardware, and firmware that allows computer 1801 to communicate with other computers through WAN 1802. Network module 1815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the inventive methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801), and may take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 may be a client device, such as thin client, heavy client, mainframe computer, desktop computer and so on.

REMOTE SERVER 1804 is any computer system that serves at least some data and/or functionality to computer 1801. Remote server 1804 may be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data may be provided to computer 1801 from remote database 1830 of remote server 1804.

PUBLIC CLOUD 1805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1805 is performed by the computer hardware and/or software of cloud orchestration module 1841. The computing resources provided by public cloud 1805 are typically implemented by virtual computing environments that run on various computers making up the computers of host physical machine set 1842, which is the universe of physical computers in and/or available to public cloud 1805. The virtual computing environments (VCEs) typically take the form of virtual machines from virtual machine set 1843 and/or containers from container set 1844. It is understood that these VCEs may be stored as images and may be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware, and firmware that allows public cloud 1805 to communicate through WAN 1802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1805 and private cloud 1806 are both part of a larger hybrid cloud.

What is claimed is:

1. A computer-implemented system, comprising:
a memory configured to store computer executable components; and
a processor configured to execute the computer executable components stored in the memory, wherein the computer executable components comprise:
a filtering component that filters a first undirected graph of a three-dimensional (3D) point cloud, by eliminating one or more edges of the first undirected graph that are longer than an adaptive threshold, wherein filtering the first undirected graph produces a second undirected graph; and
a detection component that detects a minimum cycle basis of the second undirected graph to determine a cycle path that traverses an irregular annular shape that is represented by the 3D point cloud.

2. The computer-implemented system of claim 1, further comprising:
a graphing component that generates the first undirected graph of the 3D point cloud, wherein the graphing component allocates individual distances between individual nodes of the first undirected graph as edge weights of respective edges connecting the individual nodes.

3. The computer-implemented system of claim 1, wherein the filtering component employs at least one of voxel downsampling or radius filtering to reduce density of an input 3D point cloud to produce the 3D point cloud.

4. The computer-implemented system of claim 1, wherein the adaptive threshold is defined as being equal to a distance between a first pair of nodes comprised in a first cluster of the first undirected graph such that an edge connecting the first pair of nodes is longer than a first defined threshold.

5. The computer-implemented system of claim 4, further comprising:
a clustering component that performs clustering on a plurality of edges of the first undirected graph to generate a plurality of clusters comprising at least the first cluster, wherein the clustering is performed based on individual edge distances of the plurality of edges.

6. The computer-implemented system of claim 4, wherein the first cluster is defined such that an average value of individual edge distances of respective individual edges comprised in the first cluster is smaller than a second defined threshold, and wherein the average value of individual edge distances is computed by a computation component.

7. The computer-implemented system of claim 5, wherein a quantity of clusters is half of a quantity of a first plurality of nodes in the first undirected graph, and wherein the clustering is performed using machine learning algorithms.

8. The computer-implemented system of claim 1, wherein the detection component detects the cycle path based on the minimum cycle basis such that the cycle path has a length greater than respective lengths of individual cycles of the minimum cycle basis.

9. The computer-implemented system of claim 1, wherein the detection component further detects whether the cycle path traverses all nodes in the second undirected graph, to determine whether the irregular annular shape is a closed ring shape.

10. A computer-implemented method, comprising:
filtering, by a system operatively coupled to a processor, a first undirected graph of a 3D point cloud, by eliminating one or more edges of the first undirected graph that are longer than an adaptive threshold, wherein filtering the first undirected graph produces a second undirected graph; and
detecting, by the system, a minimum cycle basis of the second undirected graph to determine a cycle path that traverses an irregular annular shape that is represented by the 3D point cloud.

11. The computer-implemented method of claim 10, further comprising:
generating, by the system, the first undirected graph of the 3D point cloud, wherein a graphing component allocates individual distances between individual nodes of the first undirected graph as edge weights of respective edges connecting the individual nodes.

12. The computer-implemented method of claim 10, further comprising:
employing, by the system, at least one of voxel downsampling or radius filtering to reduce density of an input 3D point cloud to produce the 3D point cloud.

13. The computer-implemented method of claim 10, wherein the adaptive threshold is defined as being equal to a distance between a first pair of nodes comprised in a first cluster of the first undirected graph such that an edge connecting the first pair of nodes is longer than a first defined threshold.

14. The computer-implemented method of claim 13, further comprising:
performing, by the system, clustering on a plurality of edges of the first undirected graph to generate a plurality of clusters comprising at least the first cluster, wherein the clustering is performed based on individual edge distances of the plurality of edges.

15. The computer-implemented method of claim 13, further comprising:
computing, by the system, an average value of individual edge distances of respective individual edges comprised in the first cluster, wherein the first cluster is defined such that the average value of individual edge distances is smaller than a second defined threshold.

16. The computer-implemented method of claim 14, wherein a quantity of clusters is half of a quantity of a first plurality of nodes in the first undirected graph, and wherein the clustering is performed using machine learning algorithms.

17. The computer-implemented method of claim 10, further comprising:
detecting, by the system, the cycle path based on the minimum cycle basis such that the cycle path has a length greater than respective lengths of individual cycles of the minimum cycle basis.

18. The computer-implemented method of claim 10, further comprising:
detecting, by the system, whether the cycle path traverses all nodes in the second undirected graph, to determine whether the irregular annular shape is a closed ring shape.

19. A computer program product for a workflow for detecting a closed ring shape in a 3D point cloud, the computer program product comprising a computer readable storage medium having program instructions embodied therewith, the program instructions executable by a processor to cause the processor to:
filter, by the processor, a first undirected graph of the 3D point cloud, by eliminating one or more edges of the first undirected graph that are longer than an adaptive threshold, wherein filtering the first undirected graph produces a second undirected graph; and
detect, by the processor, a minimum cycle basis of the second undirected graph to determine a cycle path that traverses an irregular annular shape that is represented by the 3D point cloud.

20. The computer program product of claim 19, wherein the program instructions are further executable by the processor to cause the processor to:
generate, by the processor, the first undirected graph of the 3D point cloud, wherein a graphing component allocates individual distances between individual nodes of the first undirected graph as edge weights of respective edges connecting the individual nodes.
